(19) United States
(12) Patent Application Publication
(10) Pub. No.: US 2025/0316079 A1
(43) Pub. Date: Oct. 9, 2025

(54) METHOD AND APPARATUS FOR IDENTIFYING SOLID PHASE SUBSTANCE IN FRACTURE IN CORE, AND DEVICE AND MEDIUM

(71) Applicant: ICORE GROUP INC, Shenzhen (CN)

(72) Inventors: Wei Long, Shenzhen (CN); Zhao XIONG, Shenzhen (CN); Guanqun WANG, Shenzhen (CN); Haipeng SHAO, Shenzhen (CN); Wei Ll, Shenzhen (CN); Cheng ZAN, Shenzhen (CN)

(21) Appl. No.: 19/173,980

(22) Filed: Apr. 9, 2025

(30) Foreign Application Priority Data
Apr. 9, 2024 (CN) 202410423074.X

(51) Int. Cl. G06V 20/10; G01N 23/046; G06V 10/75; G06V 10/82

(52) U.S. Cl. CPC G06V 20/10; G01N 23/046; G06V 10/751; G06V 10/82

(57) ABSTRACT

The present disclosure provides a method and apparatus for identifying a solid phase substance in a core fracture, and a device and a medium. The method for identifying a solid phase substance in a core fracture includes: acquiring a first scanned grayscale image of a core to be identified; acquiring a second scanned grayscale image of a core fracture template filled with reference solid phase substances; generating a solid phase substance grayscale template based on the second scanned grayscale image, different grayscale value ranges in the solid phase substance grayscale template representing reference solid phase substances with different compositions filling the core fracture of the core fracture template; and comparing the first scanned grayscale image based on the solid phase substance grayscale template to identify the composition of a target solid phase substance in the core fracture of the core to be identified.

### TECHNICAL FIELD

The present disclosure relates to the field of petroleum exploration, and in particular relates to a method and apparatus for identifying a solid phase substance in a core fracture, and a device and a medium.

### BACKGROUND

In the field of petroleum exploration, in order to improve oil and gas recovery, fracturing can be performed on tight reservoirs such as a shale. Fracturing can significantly increase the permeability of reservoir rocks, thereby expanding oil and gas flow channels and improving oil and gas recovery. During the fracturing, fracturing fluid containing proppant needs to be injected into the reservoir. The proppant, being deposited, will form a proppant solid phase substance within a reservoir fracture, forming a skeleton that supports the opening of the core fracture. When evaluating the effect of fracturing, identifying the composition of the solid phase substance during the fracturing can determine whether the fracturing has achieved the expected modification effect.

However, in existing technology, it is easy to damage the core when identifying the solid phase substance during the fracturing, and the identification accuracy is low.

### SUMMARY

Embodiments of the present disclosure provide a method and apparatus for identifying a solid phase substance in a core fracture, and a device and a medium. Accordingly, the accuracy of identification of the solid phase substance in the core fracture can be improved without damaging the core.

According to an aspect of the present disclosure, an embodiment provides a method for identifying a solid phase substance in a core fracture, including:
acquiring a first scanned grayscale image of a core to be identified, the core fracture in the core to be identified being filled with a target solid phase substance, and the first scanned grayscale image being obtained by scanning, on an outside of a core barrel, the core to be identified that is protected by the core barrel;
acquiring a second scanned grayscale image of a core fracture template filled with reference solid phase substances;
generating a solid phase substance grayscale template based on the second scanned grayscale image, different grayscale value ranges in the solid phase substance grayscale template representing the reference solid phase substance of different compositions filling the core fracture of the core fracture template; and
comparing the first scanned grayscale image based on the solid phase substance grayscale template to identify the composition of the target solid phase substance in the core fracture to be identified.

According to an aspect of the present disclosure, an embodiment provides an apparatus for identifying a solid phase substance in a core fracture, including:
a first acquisition unit, configured to acquire a first scanned grayscale image of a core to be identified, the core fracture in the core to be identified being filled with a target solid phase substance, and the first scanned grayscale image being obtained by scanning, on an outside of a core barrel, the core to be identified that is protected by the core barrel;
a second acquisition unit, configured to acquire a second scanned grayscale image of a core fracture template filled with reference solid phase substances;
a generation unit, configured to generate a solid phase substance grayscale template based on the second scanned grayscale image, different grayscale value ranges in the solid phase substance grayscale template representing the reference solid phase substances with different compositions filling the core fracture of the core fracture template; and
a comparison unit, configured to compare the first scanned grayscale image based on the solid phase substance grayscale template to identify the composition of the target solid phase substance in the core fracture of the core to be identified.

In an implementation, the generation unit is specifically configured to:
acquire a distribution map of the reference solid phase substances with a plurality of compositions in the core fracture template;
partition the second scanned grayscale image according to the distribution map; and
generate a solid phase substance grayscale template based on the reference solid phase substances corresponding to a plurality of partitions of the second scanned grayscale image.

In an implementation, the second acquisition unit is configured to:

in response to a zoning result of the reference solid phase substances with a plurality of compositions in a fractured core fracture template, generate a distribution map.

In an implementation, the reference solid phase substances include a proppant solid phase substance, a mud solid phase substance, and a mixture of the proppant solid phase substance and the mud solid phase substance, where the mixture includes a plurality of mixing ratios;
the generation unit is specifically configured to:
determine a proppant grayscale value range corresponding to the proppant solid phase substance based on a corresponding partition of the proppant solid phase substance in the second scanned grayscale image;
determine a mud grayscale value range corresponding to the mud solid phase substance based on a corresponding partition of the mud solid phase substance in the second scanned grayscale image;
determine a plurality of mixture grayscale value ranges based on corresponding partitions of the mixtures with the plurality of mixing ratios in the second scanned grayscale image; and
generate a solid phase substance grayscale template based on the proppant grayscale value range, the mud grayscale value range, and the plurality of mixture grayscale value ranges.

In an implementation, the comparison unit is specifically configured to:
train a preset neural network model based on the solid phase substance grayscale template; and
input the first scanned grayscale image into the preset neural network model to quantitatively identify the composition of the target solid phase substance in the core fracture of the core to be identified.

In an implementation, the comparison unit is specifically configured to:
cluster the grayscale values of the core fracture in the first scanned grayscale image, and perform feature extraction for each class to obtain grayscale image features;
perform feature extraction on the solid phase substance grayscale template to obtain a plurality of template features corresponding to the reference solid phase substances with a plurality of compositions; and
perform feature matching among the plurality of template features by using the grayscale image features, and identify, based on a matching result, the composition of the target solid phase substance in the core fracture of the core to be identified.

In an implementation, the first acquisition unit is specifically configured to:
acquire, by using a computed tomography technology, a plurality of slice images in the core to be identified;
perform three-dimensional reconstruction based on the plurality of slice images to obtain a preprocessed grayscale image; and
perform image enhancement and image noise reduction for the preprocessed grayscale image to obtain a first scanned grayscale image.

According to an aspect of the present disclosure, an embodiment provides an electronic device, including a memory and a processor. The memory stores a computer program which, when executed by the processor, implements the above-described method for identifying a solid phase substance in a core fracture.

According to an aspect of the present disclosure, an embodiment provides a computer-readable storage medium, storing a computer program which, when executed by a processor, implements the above-described method for identifying a solid phase substance in a core fracture.

In embodiments of the present disclosure, the first scanned grayscale image is obtained by scanning the core to be identified on the outside of the core barrel, where the core is protected by the core barrel. The second scanned grayscale image of the core fracture template filled with the reference solid phase substances is acquired, and the solid phase substance grayscale template is generated based on the second scanned grayscale image, the solid phase substance grayscale template indicating grayscale value ranges of the reference solid phase substances of different compositions after scanning; and the first scanned grayscale image is compared with the solid phase substance grayscale template, and corresponding types of reference solid phase substances are determined based on the grayscale values of each pixel in the first scanned grayscale image, thereby identifying the target solid phase substance included in fracturing of the core to be identified. A grayscale value can reflect the degree of radiation absorption of different solid phase substances, and it is more accurate to use the grayscale value to identify the solid phase substance in the core fracture. Therefore, by using the method for identifying the solid phase substance in the core fracture provided in an embodiment of the present disclosure, the accuracy of identification of the solid phase substance in the core fracture can be improved without damaging the core.

Additional features and advantages of the present disclosure will be set forth in the specification which follows, and, in part, will be apparent from the specification, or may be learned by practice of the present disclosure. The objectives and other advantages of the present disclosure can be realized and obtained by the structure particularly pointed out in the specification, claims and appended drawings.

### BRIEF DESCRIPTION OF DRAWINGS

The drawings are used to provide a further understanding of the technical solutions of the present disclosure and form a part of the specification, and together with the embodiments of the present disclosure, are used to explain the technical solutions of the present disclosure and do not constitute a limitation of the technical solutions of the present disclosure.

FIG. 1 is an architecture diagram of a system applied to a method for identifying a solid phase substance in a core fracture according to an embodiment of the present disclosure;

FIG. 2 is a flowchart of a method for identifying a solid phase substance in a core fracture provided by an embodiment of the present disclosure;

FIG. 3 is a flowchart of step 210 provided according to an embodiment of the present disclosure;

FIG. 4 is a schematic diagram of arranging reference solid phase substances with different compositions in three areas of a fracture surface of a core fracture template, according to an embodiment of the present disclosure;

FIG. 5 is a schematic diagram of partitioning a second scanned grayscale image according to a distribution map, according to an embodiment of the present disclosure;

FIG. 6 is a schematic diagram of a fracture grayscale value in a first scanned grayscale image, according to an embodiment of the present disclosure;

FIG. 7 is a schematic structural diagram of an apparatus for identifying a solid phase substance in a core fracture according to an embodiment of the present disclosure;

FIG. 8 is a terminal structure diagram for implementing various methods according to an embodiment of the present disclosure; and

FIG. 9 is a server structure diagram for implementing the various methods according to an embodiment of the present disclosure.

### DETAILED DESCRIPTION

In order to make the objectives, technical solutions, and advantages of the present disclosure more clear, the present disclosure will be further described in detail below with reference to the drawings and embodiments. It should be understood that the specific embodiments described here are only used to explain the present disclosure rather than limiting the present disclosure.

Before further describing the embodiments of the present disclosure in detail, the nouns and terms involved in the embodiments of the present disclosure are explained. The nouns and terms involved in the embodiments of the present disclosure are applicable to the following explanations:

Core: a cylindrical rock sample taken from an underground rock. In the fields of geological exploration, petroleum engineering and environmental science and the like, the core is a very important research material because it provides direct geological information and physical and chemical properties of underground rocks, and can be used for geological research, reservoir evaluation, resources development and the like. The core is typically obtained during drilling by means of a specialized coring tool and is kept in a sealed core barrel to prevent contamination and alteration. The size, shape and sampling depth of a core depend on the specific research objectives and application requirements. Through detailed analysis and testing of the core, valuable geological data and underground resource information can be obtained.

Hydraulic fracturing: an oil and gas field development technology used to increase the production of oil and gas wells. This technology involves injecting high-pressure fracturing fluid into oil and gas wells at pressures exceeding the fracture pressure threshold of the rock, thereby forming fractures or propagating natural fractures in the reservoir formation. These fractures serve as channels for the flow of oil and gas, which can significantly improve the efficiency of oil and gas flow from the reservoir to the wellbore, thereby increasing oil and gas production. The fracturing process typically involves the following steps: drilling, fracturing fluid injection, fracture propagation, proppant deposition, pressure depletion, and oil and gas production.

Computed tomography technology (CT technology): a medical imaging technology that uses computers to process penetration images obtained via X-rays or other forms of radiation to generate three-dimensional images of the interior of the scanned object. The CT technology is widely used in medical diagnosis, industrial testing, geological exploration and other fields.

### System Architecture Adopted by the Embodiments of the Present Disclosure

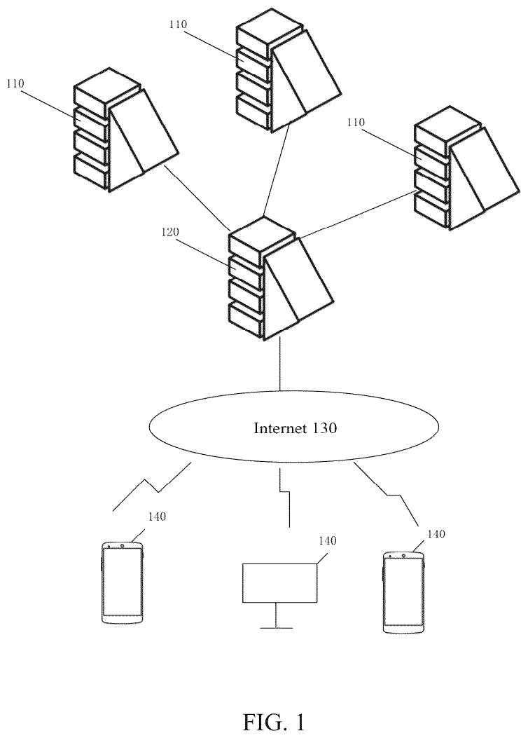

FIG. 1 is an architecture diagram of a system applied to a method for identifying a solid phase substance in a core fracture according to an embodiment of the present disclosure. The system includes a terminal 140, the Internet 130, a gateway 120, a server 110, and the like. The terminal 140 includes desktop computers, laptop computers, PDAs (personal digital assistants), mobile phones, vehicle-mounted terminals, home theater terminals, dedicated terminals, and other forms. In addition, the terminal 140 can be a single device or a collection of a plurality of devices. For example, a plurality of devices are connected through a local area network and use a display device to work together to form the terminal 140. The terminal 140 can also communicate with the Internet 130 in a wired or wireless manner to exchange data.

The server 110 refers to a computer system that can provide certain services to the terminal 140. Compared with the ordinary terminal 140, the server 110 has very high requirements in terms of stability, security, performance, and the like. The server 110 may be a high-performance computer in a network platform, a cluster of a plurality of high-performance computers, a portion of a high-performance computer (such as a virtual machine), or a combination of portions (such as virtual machines) of a plurality of high-performance computers, and the like.

The gateway 120 is also called an inter-network connector or a protocol converter. A gateway implements network interconnection at the transport layer and is a computer system or device that acts as a conversion function. A gateway is a translator between two systems that use different communication protocols, data formats or languages, or even completely different architectures. Moreover, the gateway can also provide filtering and security functions. A message sent by the terminal 140 to the server 110 is sent to the corresponding server 110 through the gateway 120. A message sent by the server 110 to the terminal 140 is also sent to the corresponding terminal 140 through the gateway 120.

The method for identifying a solid phase substance in a core fracture according to an embodiment of the present disclosure can be implemented entirely at the terminal 140, can be implemented entirely at the server 110, or can be implemented partly at the terminal 140 and partly at the server 110.

### General Description of the Embodiments of the Present Disclosure

According to an embodiment of the present disclosure, a method for identifying a solid phase substance in a core fracture is provided. When designing reservoir fracturing means, experiments of post-fracturing coring can be used to evaluate the effect of fracturing. A well location suitable for post-fracturing coring is first selected. Generally, an area that can represent the fracturing effect and can safely perform coring operations is selected. According to geological conditions, reservoir characteristics, fracturing design, and the like, coring is performed after the depth and location of the coring are determined; and fracturing operations are carried out on the removed target core. When fracturing the target core, a pressure is applied to a core sample through a pressure pump to simulate an in-situ stress state and a pore fluid pressure of the underground rock. Under simulated in-situ stress conditions, high-pressure fracturing fluid is injected to form rock fractures. The fracturing fluid is a mixture containing large amounts of water, proppant and chemical additives. As a rock fracture propagates, the proppant in the fracturing fluid will be deposited in the core fracture to form the solid phase substance in the core fracture, so as to keep the core fracture open. Therefore, when evaluating the fracturing effect, it is very important to identify and analyze the solid phase substance in the core fracture, which can help technicians understand the distribution of the core fracture network in a timely manner and determine whether the expected fracturing effect is achieved.

One embodiment of the present disclosure provides a method for identifying a solid phase substance in a core fracture, which can be used to identify the composition of the solid phase substance in the core fracture without damage, thereby analyzing the fracturing effect. Non-destructive identification method can quickly identify the solid phase substance in the core in the mining site, such that the technicians can quickly understand the distribution of core fracture network, thereby improving mining efficiency.

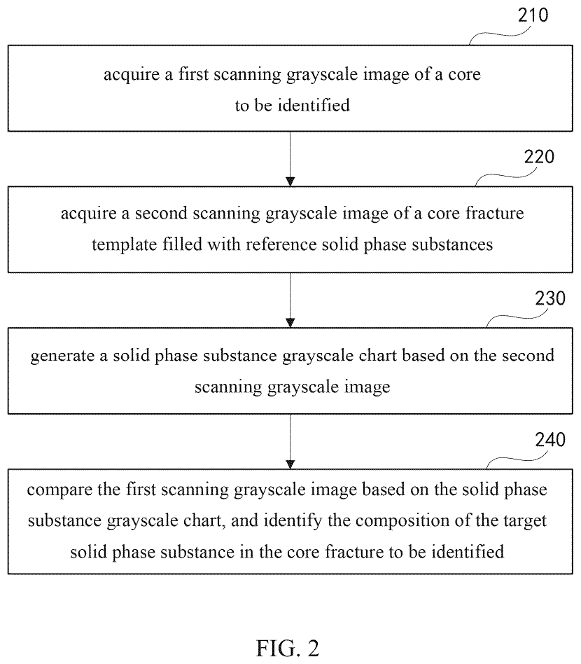

As shown in FIG. 2, the method can include:
Step 210: a first scanned grayscale image of a core to be identified is acquired;
Step 220: a second scanned grayscale image of a core fracture template filled with reference solid phase substances is acquired;
Step 230: a solid phase substance grayscale template based on the second scanned grayscale image is generated; and
Step 240: the first scanned grayscale image based on the solid phase substance grayscale template is compared to identify the composition of the target solid phase substance in the core fracture of the core to be identified.

In step 210, the core to be identified may be a target core taken out during a fracturing experiment, and specifically may be a full-diameter core with casing. The full-diameter core with casing may be a complete cylindrical core sample containing the original rock and a surrounding casing material, for example, a cylindrical sample with a radius equal to 5 cm. The surrounding casing material may be called a core barrel, and its function is to protect the core sample and ensure the integrity of the core sample for accurate experimental analysis and research.

The core fracture of the core to be identified is filled with the target solid phase substance. The target solid phase substance may be proppant deposited by the fracturing fluid during the fracturing process. The proppant may have a plurality of compositions, such as a sand proppant, a ceramic proppant, a polymer proppant, and the like. According to the characteristics of the reservoir, the formation and propagation of fracture, and the like, different proppants can be selected for fracturing. For example, the sand proppant is both supportive and cost-effective; the ceramic proppant can be used in high-temperature and high-pressure reservoir environments; and the polymer proppant has high adaptability and plasticity and can provide effective support in complex fractures.

The target solid phase substance may also be the mud remaining in the drilling fluid during the drilling process, or a mixture of the proppant and the mud. The mud remaining in fracture may block pores, reduce reservoir permeability, and affect the flow of oil and gas. Therefore, identifying the mud in the target solid phase substance is very important for the evaluation of fracturing.

The first scanned grayscale image is obtained by scanning, on an outside of the core barrel, the core to be identified that is protected by the core barrel. On the outside of the core barrel, scanning the core protected inside the core barrel can ensure that the core is not damaged and a stable core storage environment is maintained.

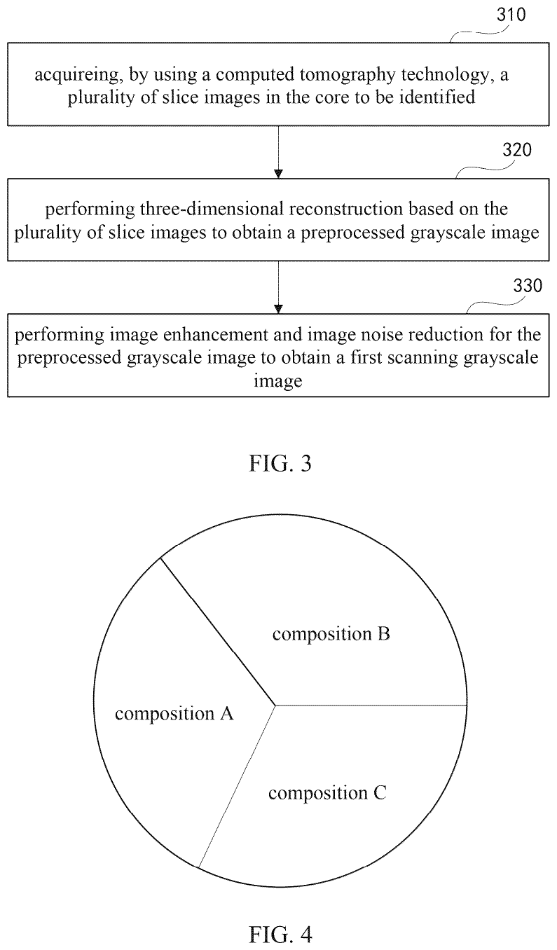

In an implementation, as shown in FIG. 3, the acquiring a first scanned grayscale image of a core to be identified includes:
Step 310: by using computed tomography technology, a plurality of slice images in the core to be identified is acquired;
Step 320: three-dimensional reconstruction is performed based on the plurality of slice images to obtain a preprocessed grayscale image; and
Step 330: image enhancement and image noise reduction are performed for the preprocessed grayscale image to obtain a first scanned grayscale image.

The computed tomography technology, also known as CT technology. The computed tomography device (i.e., CT device) can use X-rays to penetrate the scanned core to be identified. Then, the CT device can generate, according to the degree of absorption of X-rays inside the core to be identified, a plurality of two-dimensional slice images of the interior of the core to be identified. The scanning spatial resolution of the CT device can be no less than 70 microns, the scanning voltage can be maintained at 200 kilovolts, and the scanning current can be maintained at 0.6 milliampere. By stacking a plurality of consecutive two-dimensional slice images, a three-dimensional image of the interior of the core to be identified can be constructed, which is a preprocessed grayscale image. Upon experimental verification, scanning to obtain more than 1080 two-dimensional slice images can obtain a clear and reliable three-dimensional image, and the rock skeleton and fracture can be clearly distinguished.

Rocks and solid phase substances can be clearly distinguished in the preprocessed grayscale image. This is because the mineral composition and density of rocks and solid materials are different, resulting in different absorption and scattering properties of X-rays. For example, rocks with a higher density can absorb more X-rays and will show higher grayscale values in the preprocessed grayscale image; the solid phase substances in the core fractures with a lower density absorb less X-rays and will show lower grayscale values in the preprocessed grayscale image.

In order to make the difference between the solid phase substances with different compositions in the preprocessed grayscale image more significant, image enhancement can be performed on the preprocessed grayscale image. Image enhancement can improve the contrast between different areas in an image and highlight details in the image. Specifically, image enhancement methods may include: adjusting the histogram distribution of the preprocessed grayscale image to enhance the contrast and details of the preprocessed grayscale image; and highlighting or suppressing specific frequency compositions in the preprocessed grayscale image by using a filter; and the like.

In order to reduce or eliminate the noise in the preprocessed grayscale image and improve the image quality, image noise reduction can be performed on the preprocessed grayscale image. Image noise reduction methods may include mean filtering, Gaussian filtering, etc.

Acquiring, based on the computed tomography and three-dimensional reconstruction technology, a grayscale image of the interior of the core to be identified can ensure that clear internal images of the core are acquired without damaging the core, improving the safety of fracturing evaluation. Performing image enhancement and image noise reduction for the preprocessed grayscale image to obtain the first scanned grayscale image can improve image clarity, and make the difference between the solid phase substances with different compositions more significant, helping improve the accuracy of identification of the solid phase substance.

The grayscale value deviation may occur when the core to be identified is scanned. In an implementation, acquiring a first scanned grayscale image of the core to be identified includes:
scanning the core to be identified a preset number of times to obtain a plurality of error grayscale images;
determining, for each pixel of a plurality of pixels corresponding to the core to be identified and based on grayscale values corresponding to the pixels in the plurality of error grayscale images, a result grayscale value to obtain a plurality of result grayscale values;
acquiring the first scanned grayscale image of the core to be identified based on the plurality of result grayscale values each corresponding to a respective one of the plurality of pixels.

After the core to be identified is taken out, the core to be identified can be scanned a preset number of times to obtain a plurality of error grayscale images. The error grayscale images obtained by different scans may be different. Therefore, for each pixel corresponding to the core to be identified, the respective result grayscale value can be determined based on the respective grayscale values corresponding to each pixel in the plurality of error grayscale images.

In an embodiment, the result grayscale values are determined based on the grayscale values corresponding to the pixels in the plurality of error grayscale images. In an example, the result grayscale value can be obtained by calculating the average value of the plurality of grayscale values for each pixel. For example, in the case where the core to be identified is scanned five times, for the same pixel, the corresponding grayscale values of the pixel in the five error grayscale images are 56, 62, 58, 63 and 60 respectively, then the result grayscale values of the pixel is (56+62+58+63+60)/5=59.8.

In another embodiment, determining the result grayscale values based on the grayscale values corresponding to the pixels in the plurality of error grayscale images includes: removing an abnormal value in the plurality of grayscale values, and then obtaining the result grayscale value by calculating the average value of the remaining grayscale values.

The abnormal value can be a value that deviates greatly from other grayscale values among a plurality of grayscale values. The abnormal value may be generated due to errors and interference in the scanning process. If the abnormal value is considered when calculating the result grayscale value, the result will be affected. For example, in the case where the core to be identified is scanned five times, for the same pixel, the grayscale values corresponding to the pixel in the five error grayscale images are 56, 62, 58, 63 and 20 respectively, in which the value of 20 deviates greatly from other grayscale values and can be regarded as an abnormal value. After removing the abnormal value, the grayscale value calculated based on the remaining grayscale values is (56+62+58+63)/4=59.75.

After obtaining the result grayscale value corresponding to each pixel, the first scanned grayscale image can be constructed based on the result grayscale values corresponding to the pixels in the core to be identified. In this way, the grayscale value corresponding to each pixel in the first scanned grayscale image is not only determined by a single scan, but determined by multiple scans.

In this way, the grayscale value of each pixel is determined based on a plurality of error grayscale images, and finally the first scanned grayscale image can be obtained, which can reduce the interference caused by scanning errors and sample deviations, thus improving the accuracy of the generated first scanned grayscale image.

In step 220, a second scanned grayscale image of a core fracture template filled with reference solid phase substances are acquired.

The core fracture template may be a short core without casing. After filling the solid phase substance into the core fracture of the core fracture template, the core fracture template is scanned to obtain a second scanned grayscale image. The filled solid phase substance is known. In addition, the grayscale values obtained by the computed tomography technology are different for different solid phrase substances. Therefore, the corresponding relationship between the solid phase substance and the grayscale value range can be acquired through the second scanned grayscale image. It can be demonstrated from experimental results that the second scanned grayscale image obtained by scanning the core fracture template filled with reference solid phase substance many times has high repeatability and the error is less than 2%. Therefore, the mapping relationship between the grayscale value displayed in the second scanned grayscale image and the solid phase substance is relatively accurate.

In an implementation, the core fracture template filled with reference solid phase substances are acquired in the following manner:
the core fracture template is divided into two sections;
the reference solid phase substances prepared in advance are laid on one section of the core fracture template; and
the two sections of the core are combined to obtain a core fracture template filled with the reference solid phase substances.

In order to use one core fracture template to acquire a grayscale value range of the solid phase substances with the plurality of compositions, the reference solid phase substances with a plurality of compositions can be prepared in advance and classified and laid in certain areas. For example, the solid phase substances with three compositions are prepared in advance, the fracture surface is divided into three 120-degree sector areas, and the solid phase substance with one composition is laid out in one area. As shown in FIG. 4, the reference solid phase substances with composition A, composition B and composition C are respectively laid out in three areas of one fracture surface. After laying out the solid phase substances in different areas, the compositions of the solid phase substances in each area can be marked on the core fracture template.

The method of acquiring a second scanned grayscale image of a core fracture template can be the same as the method of acquiring a first scanned grayscale image of a core to be identified, which will not be repeated here.

In step 230, a solid phase substance grayscale template may be generated based on the second scanned grayscale image. Different grayscale value ranges in the solid phase substance grayscale template represent reference solid phase substances with different compositions filling the core fracture of the core fracture template.

In an implementation, the generating a solid phase substance grayscale template based on the second scanned grayscale image includes:
a distribution map of the reference solid phase substances with a plurality of compositions is acquired in the core fracture template;
the second scanned grayscale image is partitioned according to the distribution map; and
a solid phase substance grayscale template is generated based on the reference solid phase substances corresponding to a plurality of partitions of the second scanned grayscale image.

The distribution map indicates the distribution of the reference solid phase substances with a plurality of compositions filling the core fracture template.

In one of the aforementioned implementations, the core fracture template is filled by laying the solid phase substances on one fracture surface of a fractured core fracture template. On this basis, in an implementation, the acquiring a distribution map of the reference solid phase substances with a plurality of compositions in the core fracture template includes: in response to a zoning result of the reference solid phase substances with a plurality of compositions in a fractured core fracture template, generating a distribution map.

The distribution map generated based on the zoning result can clearly show the filling positions of the reference solid phase substances with different compositions in the core fracture template, so that the comparison between the filling distribution of the solid phase substances and the second scanned grayscale image is more intuitive.

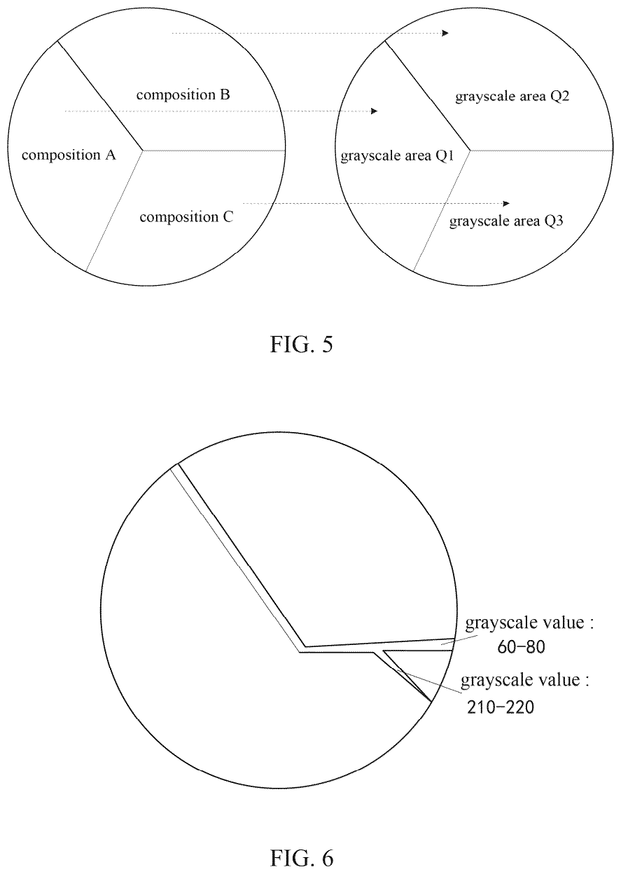

Since the distribution map corresponds to the second scanned grayscale image, the second scanned grayscale image can be partitioned according to the distribution map. For example, as shown in FIG. 5, the left side of the figure is the distribution map, and the right side of the figure is the second scanned grayscale image. The grayscale area Q1 corresponds to composition A, the grayscale area Q2 corresponds to composition B, and the grayscale area Q3 corresponds to composition C.

After partitioning the second scanned grayscale image, a solid phase substance grayscale template can be generated based on the corresponding relationship between the reference solid phase substances and the partitions. For example, in FIG. 5, the grayscale value range of pixels in the grayscale area Q1 is 120-190, the grayscale value range of pixels in the grayscale area Q2 is 56-115, and the grayscale value range of pixels in the grayscale area Q3 is 205-235. Therefore, the solid phase substance grayscale template generated based on the corresponding relationship between the reference solid phase substances and the partitions can be expressed as Table 1:

TABLE 1

| Reference solid phase substances | Grayscale value range |
|---|---|
| Composition A | 120-190 |
| Composition B | 56-115 |
| Composition C | 205-235 |

In Table 1, the grayscale value range corresponding to the reference solid phase substance with the composition A is 120-190; the grayscale value range corresponding to the reference solid phase substance with the composition B is 56-115; and the grayscale value range corresponding to the reference solid phase substance with the composition C is 205-235.

In an implementation, the reference solid phase substances include a proppant solid phase substance, a mud solid phase substance, and a mixture of the proppant solid phase substance and the mud solid phase substance, where the mixture includes a plurality of mixing ratios. That is to say, when filling the reference solid phase substance into the core fracture template, only the proppant solid phase substance, only the mud solid phase substance, or the mixture of the proppant solid phase substance and the mud mutual material in various mixing ratios can fill the core.

Therefore, the generating a solid phase substance grayscale template based on the reference solid phase substances corresponding to a plurality of partitions of the second scanned grayscale image includes:
a proppant grayscale value range corresponding to the proppant solid phase substance is determined based on a corresponding partition of the proppant solid phase substance in the second scanned grayscale image;
a mud grayscale value range corresponding to the mud solid phase substance is determined based on a corresponding partition of the mud solid phase substance in the second scanned grayscale image;
a plurality of mixture grayscale value ranges are determined based on corresponding partitions of the mixtures with the plurality of mixing ratios in the second scanned grayscale image; and
a solid phase substance grayscale template is generated based on the proppant grayscale value range, the mud grayscale value range, and the plurality of mixture grayscale value ranges.

For example, the proppant grayscale value range in the partition corresponding to the proppant solid phase substance is 10-50; the mud grayscale value range in the partition corresponding to the mud solid phase substance is 190-240; the mixture grayscale value range in the partition corresponding to a mixture with a mixing ratio of 1:4 (the proppant solid phase substance accounts for 1 part and the mud solid phase substance accounts for 4 parts) is 150-180; and the mixture grayscale value range in the partition corresponding to a mixture with a mixing ratio of 3:2 (the proppant solid phase substance accounts for 3 parts and the mud solid phase substance accounts for 2 parts) is 80-115. The solid phase substance grayscale template generated based on this can be expressed as Table 2.

TABLE 2

| Reference solid phase substances | Grayscale value range |
|---|---|
| proppant solid phase substance | 10-50 |
| Mud solid phase substance | 190-240 |
| 1:4 mixture | 150-180 |
| 3:2 mixture | 80-115 |

The proppant solid phase substance, the mud solid phase substance, and the mixture of various mixing ratios of the proppant solid phase substance and the mud solid phase substance are used as the reference solid phase substances and the corresponding solid phase substance grayscale template is generated, so that the ratio of the proppant to the mud in the solid phase substance can be identified when performing identification on the solid phase substance, and then the oil and gas transmission rate can be evaluated based on the content of the mud when performing evaluation on the fracturing effect, thereby avoiding the impact of a mud residue on the fracturing evaluation and improving the accuracy of fracturing evaluation.

The distribution map is used to divide the second scanned grayscale image into a plurality of partitions, and the grayscale value range corresponding to the reference solid phase substance of each composition is determined according to the grayscale value ranges in the plurality of partitions, so that the grayscale value range of each reference solid phase substance can be accurately determined based on the actual filling situation of the reference solid phase substances in the core fracture template, which is beneficial to improving the accuracy of generating the solid phase substance grayscale template.

In step 240, the first scanned grayscale image can be compared based on the solid phase substance grayscale template, and the composition of the target solid phase substance in the core fracture of the core to be identified can be identified.

In an implementation, the solid phase substance grayscale template visually displays the corresponding relationship between the reference solid phase substances and the grayscale value ranges. Therefore, the comparing the first scanned grayscale image based on the solid phase substance grayscale template, and identifying the composition of the target solid phase substance in the core fracture of the core to be identified includes: for each pixel point in the first scanned grayscale image, determining a grayscale value range of the grayscale value corresponding to the pixel point in the solid phase substance grayscale template; and using the composition of the reference solid phase substances corresponding to the grayscale value range as the composition of the target solid phase substance corresponding to the pixel point.

For example, as shown in FIG. 6, in a first scanned grayscale image, the grayscale value of a pixel point in a fracture is between 60 and 80. Referring to Table 1, the composition of the target solid phase substance in the core fracture is the composition B; and the grayscale value of a similar point in another fracture is between 210 and 220. Therefore, the target solid phase substance in this fracture is called the composition C.

In another implementation, the comparing the first scanned grayscale image based on the solid phase substance grayscale template, and identifying the composition of the target solid phase substance in the core fracture of the core to be identified includes:
the grayscale values of the core fracture in the first scanned grayscale image are clustered, and feature extraction is performed for each class to obtain grayscale image features;
feature extraction is performed on the solid phase substance grayscale template to obtain a plurality of template features corresponding to the reference solid phase substances with a plurality of compositions; and
feature matching is performed among the plurality of template features by using the grayscale image features, and based on a matching result, the composition of the target solid phase substance in the core fracture of the core to be identified is identified.

Since the grayscale values of a plurality of pixel points corresponding to the core fracture in the first scanned grayscale image may be very similar, the target solid phase substance can be identified uniformly for the plurality of pixel points. Specifically, the grayscale values of the core fracture in the first scanned grayscale image can be clustered. Feature extraction is performed on each class to obtain grayscale image features corresponding to the class.

Feature extraction is performed on the solid phase substance grayscale template to obtain different template features corresponding to different reference solid phase substances.

When performing feature matching using grayscale image features and template features, for each class in the first scanned grayscale image, feature matching can be performed by calculating the cosine similarity or Euclidean distance between the corresponding grayscale image features and template features, and the composition of the reference solid phase substance with the closest similarity or distance can be determined as the composition of the target solid phase substance contained in the core fractures corresponding to the class.

After clustering the grayscale values, the composition of the target solid phase substance is identified by using the similarity between the class features and the template features. Similar grayscale values can be uniformly identified, which is beneficial to improving the identification efficiency.

In one of the aforementioned implementations, a solid phase substance grayscale template is generated based on the proppant grayscale value range, the mud grayscale value range, and the plurality of mixture grayscale value ranges. On this basis, in an implementation, the comparing the first scanned grayscale image based on the solid phase substance grayscale template, and identifying the composition of the target solid phase substance in the core fracture to be identified includes:
a preset neural network model is trained based on a sample solid phase substance grayscale template; and
the first scanned grayscale image is inputted into the preset neural network model to quantitatively identify the composition of the target solid phase substance in the core fracture of the core to be identified.

The sample solid phase substance grayscale template includes a variety of sample solid substances and corresponding grayscale value labels. The sample solid phase substance can include single-component proppant, single-component mud, and mixture obtained by mixing in various proportions. When generating the sample solid phase substance grayscale template, the various sample solid phase substances can be scanned based on the zoning results to obtain the corresponding grayscale labels of the sample solid phase substances.

There is a linear relationship between the mixing ratio of solid phase substances and the grayscale value. The higher the ratio of mud in solid phase substances, the higher the grayscale value. Therefore, the relationship between different mixing ratios and grayscale values of the proppant solid phase substance and mud solid phase substance can be learned by the preset neural network model based on sample solid phase substances with multiple mixing ratios and corresponding grayscale value labels in the sample solid phase substance grayscale template.

The preset neural network model is configured to identify the composition and content of the target solid phase substance in the core fracture based on the grayscale value in the first scanned grayscale image. After the preset neural network model learns the relationship between different mixing ratios and grayscale values, even if the grayscale value in the first scanned grayscale image is not within the grayscale value ranges included in the solid phase substance grayscale template, the preset neural network model can also quantitatively identify the composition and content of the corresponding target solid phase substance.

For example, the preset neural network model learns the relationship between 100% proppant and the corresponding grayscale value range, the relationship between 100% mud and the corresponding grayscale value range, the relationship between the mixing ratio of 1:4 (the proppant solid phase substance accounts for 1 part, and the mud solid phase substance accounts for 4 parts) and the corresponding grayscale value range, and the relationship between the mixing ratio of 3:2 (the proppant solid phase substance accounts for 3 parts, and the mud solid phase substance accounts for 2 parts) and the corresponding grayscale value range. When the composition content of the target solid phase substance in the core fracture to be identified is not any of the above, it can be obtained, through the preset neural network model, that the composition of the target solid phase substance is a mixture obtained by mixing the proppant solid phase substance with the mud solid phase substance in a ratio of 2:3.

It is demonstrated from experiment results that the accuracy of identifying solid phrase substances with unknown mixing ratios by the preset neural network model can reach 90%. Therefore, the identification of composition of the target solid phase substance based on the preset neural network model can flexibly identify the target solid phase substance mixed in any ratio, which is beneficial to improving the accuracy of identification of the composition the target solid phase substance.

In the actual engineering scenario, the ratio of proppant and mud in the solid phase substance may not be accurately quantified due to the influence of environment and fracturing operation. In this regard, the identification of the target solid phase substance by the preset neural network model can improve the accuracy of fracturing evaluation in the actual engineering scenario.

### General Description of the Embodiments of the Present Disclosure in Conjunction with the Specific Application Scenarios

The method according to the embodiments of the present disclosure can be applied to the fracturing scene of oil and gas exploitation engineering. Specifically, the method includes:
applying pressure to a core sample through a pressure pump;
injecting fracturing fluid to fracture of core sample through a fracturing fluid injection device, and obtaining the core to be identified after the fracturing fluid is deposited;
acquire, by a CT device and using computed tomography technology, a plurality of slice images in the core to be identified;
performing, by a computer device, three-dimensional reconstruction on the plurality of slice images to obtain a preprocessed grayscale image; and performing image enhancement and image noise reduction on the preprocessed grayscale image to obtain a first scanned grayscale image;
dividing, by a core cutting device, the core fracture template without casing into two sections;
classifying and laying out, by a solid phase substance filling device and according to certain areas, the reference solid phase substance with a plurality of compositions, into a fracture surface of one of the two sections of the core fracture template;
acquiring, by an image acquisition device, an image from the fracture surface of the reference solid phase substance with the plurality of compositions to obtain a distribution map;
combining, by a core combining device, the two sections of the core to obtain a core fracture template filled with the reference solid phase substance;
acquire, by the CT device and using computed tomography technology, a plurality of slice images in the core fracture template;
performing, by the computer device, three-dimensional reconstruction on the plurality of slice images; and performing image enhancement and image noise reduction on the reconstructed grayscale image to obtain a second scanned grayscale image;
dividing, by the computer device and based on the distribution map according to the compositions of the reference solid phase substance, the second scanned grayscale image into a plurality of partitions, and generating a solid phase substance grayscale template based on the reference solid phase substance and the grayscale value range corresponding to each partition;
comparing, by the computer device and based on the solid phase substance grayscale template, the first scanned grayscale image, and identifying the composition of the target solid phase substance in the fracture of the core to be identified;
evaluating, by a fracturing analysis device and based on the composition of the target solid phase substance, a fracturing effect of the core sample, and optimizing a fracture network according to the fracturing effect.

Therefore, by using the method for identifying a solid phase substance in a core fracture in the embodiment of the present disclosure, the distribution of the fracture network of the core in the mining site can be quickly and accurately obtained without damaging the core, such that technicians can optimize the fracturing strategy, adjust the fracture network and improve the oil and gas production efficiency based on the distribution of the fracture network.

### Description of Apparatus and Device in the Embodiments of the Present Disclosure

It can be understood that although various steps in each of the above flowcharts are shown in sequence according to the arrows, these steps are not necessarily executed in the order represented by the arrows. Unless explicitly stated in this embodiment, the execution of these steps is not strictly limited in order, and these steps can be executed in other orders. Moreover, at least some of the steps in the above flowcharts may include a plurality of steps or a plurality of stages, and these steps or stages are not necessarily executed at the same time, but may be executed at different times. The execution order of these steps or stages does not necessarily need to be performed sequentially, but may be performed in turn or alternately with other steps or at least part of steps or stages in other steps.

It should be noted that in each specific implementation of the present disclosure, when it is necessary to perform relevant processing based on the target object attribute information or attribute information collection and other data related to the characteristics of the target object, the permission or consent of the target object will be obtained first. The collection, use and processing of these data will comply with the relevant laws, regulations and standards of relevant countries and regions. In addition, when embodiments of the present disclosure need to acquire the attribute information of a target object, the individual permission or independent consent of the target object will be obtained through a pop-up window or a jump to a confirmation page, and after clearly obtaining the individual permission or independent consent of the target object, the necessary target object related data to enable the embodiments of the present disclosure to operate normally are then acquired.

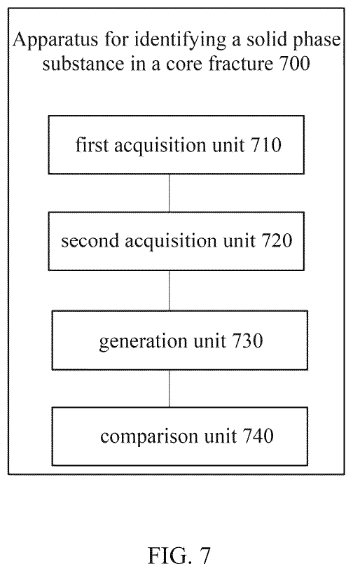

FIG. 7 is a structural diagram of an apparatus 700 for identifying a solid phase substance in a core fracture, provided by an embodiment of the present disclosure. The apparatus includes:
a first acquisition unit 710, configured to acquire a first scanned grayscale image of a core to be identified, the core fracture in the core to be identified being filled with a target solid phase substance, and the first scanned grayscale image being obtained by scanning, on an outside of a core barrel, the core to be identified that is protected by the core barrel;
a second acquisition unit 720, configured to acquire a second scanned grayscale image of a core fracture template filled with reference solid phase substances;
a generation unit 730, configured to generate a solid phase substance grayscale template based on the second scanned grayscale image, different grayscale value ranges in the solid phase substance grayscale template representing reference solid phase substances with different compositions filling the core fracture of the core fracture template; and
a comparison unit 740, configured to compare the first scanned grayscale image based on the solid phase substance grayscale template to identify the composition of the target solid phase substance in the core fracture of the core to be identified.

In an implementation, the generation unit 730 is specifically configured to:
acquire a distribution map of the reference solid phase substances with a plurality of compositions in the core fracture template;
partition the second scanned grayscale image according to the distribution map; and
generate a solid phase substance grayscale template based on the reference solid phase substances corresponding to a plurality of partitions of the second scanned grayscale image.

In an implementation, the second acquisition unit 720 is specifically configured to:
in response to a zoning result of the reference solid phase substances with a plurality of compositions in a fractured core fracture template, generate a distribution map.

In an implementation, the reference solid phase substances include a proppant solid phase substance, a mud solid phase substance, and a mixture of the proppant solid phase substance and the mud solid phase substance, where the mixture includes a plurality of mixing ratios;
the generation unit 730 is specifically configured to:
determine a proppant grayscale value range corresponding to the proppant solid phase substance based on a corresponding partition of the proppant solid phase substance in the second scanned grayscale image;
determine a mud grayscale value range corresponding to the mud solid phase substance based on a corresponding partition of the mud solid phase substance in the second scanned grayscale image;
determine a plurality of mixture grayscale value ranges based on corresponding partitions of the mixtures with the plurality of mixing ratios in the second scanned grayscale image; and
generate a solid phase substance grayscale template based on the proppant grayscale value range, the mud grayscale value range, and the plurality of mixture grayscale value ranges.

In an implementation, the comparison unit 740 is specifically configured to:
train a preset neural network model based on the solid phase substance grayscale template; and
input the first scanned grayscale image into the preset neural network model to quantitatively identify the composition of the target solid phase substance in the core fracture of the core to be identified.

In an implementation, the comparison unit 740 is specifically configured to:
cluster the grayscale values of the core fracture in the first scanned grayscale image, and perform feature extraction for each class to obtain grayscale image features;
perform feature extraction on the solid phase substance grayscale template to obtain a plurality of template features corresponding to the reference solid phase substances with a plurality of compositions; and
perform feature matching among the plurality of template features by using the grayscale image features, and identify, based on a matching result, the composition of the target solid phase substance in the core fracture of the core to be identified.

In an implementation, the first acquisition unit 710 is specifically configured to:
acquire, by using a computed tomography technology, a plurality of slice images in the core to be identified;
perform three-dimensional reconstruction based on the plurality of slice images to obtain a preprocessed grayscale image; and
perform image enhancement and image noise reduction for the preprocessed grayscale image to obtain a first scanned grayscale image.

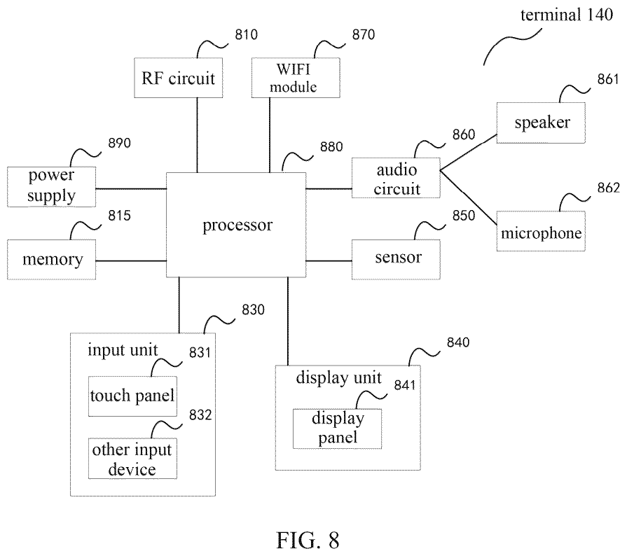

Referring to FIG. 8, FIG. 8 is a structural block diagram of a portion of an object terminal 140 that implements the embodiments of the present disclosure. The object terminal 140 includes: a radio frequency (RF) circuit 810, a memory 815, an input unit 830, a display unit 840, a sensor 850, an audio circuit 860, a wireless fidelity (WiFi) module 870, a processor 880, a power supply 890, and other components. Those skilled in the art can understand that the structure of the object terminal 140 shown in FIG. 8 does not constitute a limitation to a mobile phone or a computer, and may include more or fewer components than shown in the figure, or combine certain components, or arrange different components.

The RF circuit 810 may be configured to receive and send signals during information receiving and sending or a call. In particular, downlink information of the base station is received and then processed by the processor 880. In addition, the designed uplink data is sent to a base station.

The memory 815 may be configured to store software programs and modules. The processor 880 executes various functional applications and data processing of the object terminal 140 by running the software programs and modules stored in the memory 815.

The input unit 830 may be configured to receive input numeric or character information and generate key signal input related to settings and function control of the subject terminal 140. Specifically, the input unit 830 may include a touch panel 831 and other input devices 832.

The display unit 840 may be configured to display input information or provided information and various menus of the subject terminal 140. The display unit 840 may include a display panel 841.

The audio circuit 860, a speaker 861, and a microphone 862 can provide an audio interface.

In this embodiment, the processor 880 included in the object terminal 140 can execute the method for identifying a solid phase substance in a core fracture in the previous embodiments.

The target terminal 140 in an embodiment of the present disclosure includes but is not limited to mobile phones, computers, intelligent voice interaction devices, etc. Embodiments of the present invention can be applied to various scenarios, including but not limited to oil and gas collection, fracturing experiments, etc.

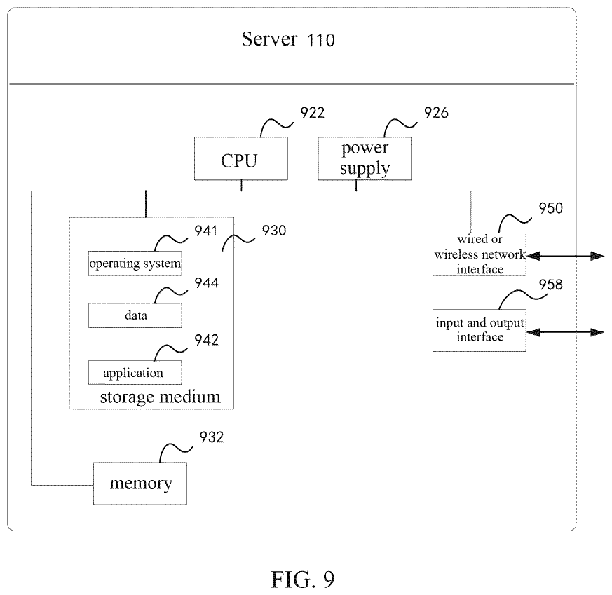

FIG. 9 is a structural block diagram of a portion of a server 110 that implements the embodiments of the present disclosure. The server 110 may vary greatly due to different configurations or performance, and may include one or more central processing units (CPU) 922 (for example, one or more processors) and a memory 932, and one or more storage media 930 (such as one or more mass storage devices) that store application programs 942 or data 944. The memory 932 and the storage medium 930 may be short-term storage or persistent storage. The program stored in the storage medium 930 may include one or more modules (not shown in the figures), and each module may include a series of instruction operations on the server 110. Furthermore, the central processing unit 922 may be configured to communicate with the storage medium 930 and execute a series of instruction operations in the storage medium 930 on the server 110.

The server 110 may also include one or more power supplies 926, one or more wired or wireless network interfaces 950, one or more input and output interfaces 958, and/or, one or more operating systems 941, such as Windows Server™, Mac OS X™, Unix™, Linux™, FreeBSD™, and the like.

The central processing unit 922 in the server 110 may be used to execute the method for identifying a solid phase substance in a core fracture according to an embodiment of the present disclosure.

An embodiment of the present disclosure also provides a computer-readable storage medium. The computer-readable storage medium is used to store program code, which is used to execute the method for identifying a solid phase substance in a core fracture of each of the abovementioned embodiments.

An embodiment of the present disclosure also provides a computer program product, which includes a computer program. A processor of a computer device reads the computer program and executes the same, so that the computer device executes the above method for identifying a solid phase substance in a core fracture.

The terms “first”, “second”, “third”, “fourth”, etc. (if present) in the specification of the present disclosure and the above drawings are used to distinguish similar objects and are not necessarily used to describe a particular order or sequence. It should be understood that data used are interchangeable under appropriate circumstances, so that the embodiments of the present disclosure described herein, for example, can be practiced in sequences other than those illustrated or described herein. Furthermore, the terms “comprise” and “include” and any variations thereof are intended to cover non-exclusive inclusions. For example, a process, method, system, product or apparatus that includes a series of steps or units needs not be limited to those explicitly listed, but may instead include other steps or elements not expressly listed or inherent to the process, method, product or apparatus.

It should be understood that, in the present disclosure, “at least one (item)” refers to one or more, and “a plurality of” refers to two or more. “And/or” is used to describe the relationship between associated objects, indicating that there can be three relationships. For example, “A and/or B” can indicate that there are three situations: only A, only B, and both A and B. A and B can be singular or plural. The character “/” generally indicates that the related objects are in an “or” relationship. “At least one (item) of the following” or similar expressions thereof refers to any combination of these items, including any combination of a single item (number) or a plurality of items (numbers). For example, at least one (item) of a, b or c can indicate: a, b, c, “a and b”, “a and c”, “b and c”, or “a and b and c”, where a, b, c can be single or multiple.

It should be understood that in the description of the embodiments of the present disclosure, the meaning of plurality (or a plurality of items) is more than two. Greater than, less than, more than, etc. are understood as excluding the number, and above, below, within, and the like are understood as including the number.

In several embodiments provided in the present disclosure, it should be understood that the disclosed system, apparatus and method can be implemented in other ways. For example, the apparatus embodiments described above are only illustrative. For example, the division of units is only a logical function division. In actual implementation, there may be other division methods. For example, a plurality of units or components may be combined or integrated to another system, or some features can be ignored, or not implemented. On the other hand, the coupling or direct coupling or communication connection between each other shown or discussed may be through some interfaces, and the indirect coupling or communication connection of the apparatus or units may be in electrical, mechanical or other forms.

Units described as separate components may or may not be physically separate. Components shown as units may or may not be physical units, that is, they may be located in one place, or may be distributed to a plurality of network units. Some or all of the units can be selected according to actual needs to achieve the objective of the solution of this embodiment.

In addition, various functional units in various embodiments of the present disclosure may be integrated into one processing unit, or each unit may exist physically alone, or two or more units may be integrated into one unit. The above integrated units can be implemented in the form of hardware or software functional units.

Integrated units may be stored in a computer-readable storage medium if implemented in the form of software functional units and sold or used as independent products. Based on this understanding, the technical solutions of the present disclosure essentially or in part contributing to the prior art or all or part of the technical solutions can be embodied in the form of a software product. The computer software product is stored in a storage medium, including several instructions for causing a computer device (which may be a personal computer, a server, or a network device, and the like.) to execute all or part of the steps of the methods of various embodiments of the present disclosure. The aforementioned storage media include: a U disk, a mobile hard disk, a read-only memory (ROM), a random access memory (RAM), a magnetic disk or an optical disk and other media that can store program code.

It should also be understood that the various implementations provided by embodiments of the present disclosure can be combined arbitrarily to achieve different technical effects.

The above is a specific description of implementations of the present disclosure, but the present disclosure is not limited to the above implementations. Those skilled in the art can also make various equivalent modifications or substitutions without violating the gist of the present disclosure. These equivalent modifications or substitutions are included within the scope defined by the claims of the present disclosure.

What is claimed is:

1. A method for identifying a solid phase substance in a core fracture, comprising:
acquiring a first scanned grayscale image of a core to be identified, the core fracture of the core to be identified being filled with a target solid phase substance, and the first scanned grayscale image being obtained by scanning, on an outside of a core barrel, the core to be identified that is protected by the core barrel;
acquiring a second scanned grayscale image of a core fracture template filled with reference solid phase substances;
generating a solid phase substance grayscale template based on the second scanned grayscale image, different grayscale value ranges in the solid phase substance grayscale template representing the reference solid phase substances with different compositions filling the core fracture of the core fracture template; and
comparing the first scanned grayscale image based on the solid phase substance grayscale template to identify the composition of the target solid phase substance in the core fracture of the core to be identified.

2. The method according to claim 1, wherein the generating a solid phase substance grayscale template based on the second scanned grayscale image comprises:
acquiring a distribution map of the reference solid phase substances with a plurality of compositions in the core fracture template;
partitioning the second scanned grayscale image according to the distribution map; and
generating a solid phase substance grayscale template based on the reference solid phase substances corresponding to a plurality of partitions of the second scanned grayscale image.

3. The method according to claim 2, wherein the acquiring a distribution map of the reference solid phase substances with a plurality of compositions in the core fracture template comprises:
in response to a zoning result of the reference solid phase substances with the plurality of compositions in a fractured core fracture template, generating a distribution map.

4. The method according to claim 2, wherein the reference solid phase substances comprise a proppant solid phase substance, a mud solid phase substance, and a mixture of the proppant solid phase substance and the mud solid phase substance, wherein the mixture comprises a plurality of mixing ratios;
the generating a solid phase substance grayscale template based on the reference solid phase substances corresponding to a plurality of partitions of the second scanned grayscale image comprises:
determining a proppant grayscale value range corresponding to the proppant solid phase substance based on a corresponding partition of the proppant solid phase substance in the second scanned grayscale image;
determining a mud grayscale value range corresponding to the mud solid phase substance based on a corresponding partition of the mud solid phase substance in the second scanned grayscale image;
determining a plurality of mixture grayscale value ranges based on corresponding partitions of the mixtures with the plurality of mixing ratios in the second scanned grayscale image; and
generating a solid phase substance grayscale template based on the proppant grayscale value range, the mud grayscale value range, and the plurality of mixture grayscale value ranges.

5. The method according to claim 4, wherein the comparing the first scanned grayscale image based on the solid phase substance grayscale template to identify the composition of the target solid phase substance in the core fracture of the core to be identified comprises:
training a preset neural network model based on the solid phase substance grayscale template; and
inputting the first scanned grayscale image into the preset neural network model to quantitatively identify the composition of the target solid phase substance in the core fracture of the core to be identified.

6. The method according to claim 1, wherein the comparing the first scanned grayscale image based on the solid phase substance grayscale template to identify the composition of the target solid phase substance in the core fracture of the core to be identified comprises:
clustering grayscale values of the core fracture in the first scanned grayscale image, and performing feature extraction for each class to obtain grayscale image features;
performing feature extraction on the solid phase substance grayscale template to obtain a plurality of template features corresponding to the reference solid phase substances with a plurality of compositions; and
performing feature matching among the plurality of template features by using the grayscale image features, and identifying, based on a matching result, the composition of the target solid phase substance in the core fracture of the core to be identified.

7. The method according to claim 1, wherein the acquiring a first scanned grayscale image of a core to be identified comprises:
acquiring, by using a computed tomography technology, a plurality of slice images in the core to be identified;
performing three-dimensional reconstruction based on the plurality of slice images to obtain a preprocessed grayscale image; and
performing image enhancement and image noise reduction for the preprocessed grayscale image to obtain a first scanned grayscale image.

8. An apparatus for identifying a solid phase substance in a core fracture, comprising:
a first acquisition unit, configured to acquire a first scanned grayscale image of a core to be identified, the core fracture of the core to be identified being filled with a target solid phase substance, and the first scanned grayscale image being obtained by scanning, on an outside of a core barrel, the core to be identified that is protected by the core barrel;
a second acquisition unit, configured to acquire a second scanned grayscale image of a core fracture template filled with reference solid phase substances;
a generation unit, configured to generate a solid phase substance grayscale template based on the second scanned grayscale image, different grayscale value ranges in the solid phase substance grayscale template representing the reference solid phase substances with different compositions filling the core fracture of the core fracture template; and
a comparison unit, configured to compare the first scanned grayscale image based on the solid phase substance grayscale template to identify the composition of the target solid phase substance in the core fracture of the core to be identified.

9. An electronic device, comprising a memory and a processor, the memory storing a computer program which, when executed by the processor, implements the method for identifying a solid phase substance in a core fracture according to claim 1.

10. A computer-readable storage medium, storing a computer program which, when executed by a processor, implements the method for identifying a solid phase substance in a core fracture according to claim 1.
